(19) United States
(12) Patent Application Publication
(10) Pub. No.: US 2025/0231796 A1
(43) Pub. Date: Jul. 17, 2025

(54) MECHANISMS FOR CONTROLLING CO-EXECUTION OF HETEROGENEOUS COOPERATIVE THREAD ARRAYS

(71) Applicant: NVIDIA Corp., Santa Clara, CA (US)

(72) Inventors: Neal Clayton Crago, Amherst, MA (US); Karthikeyan Sankaralingam, Madison, WI (US); Michael Davies, Madison, WI (US)

(73) Assignee: NVIDIA Corp., Santa Clara, CA (US)

(21) Appl. No.: 18/919,242

(22) Filed: Oct. 17, 2024

Related U.S. Application Data
(60) Provisional application No. 63/621,805, filed on Jan. 17, 2024.

(51) Int. Cl. G06F 9/48; G06F 9/38

(52) U.S. Cl. CPC G06F 9/4881; G06F 9/3851; G06F 9/3887

(57) ABSTRACT

A multithreaded processor such as a graphics processing unit comprising a scheduler configured with a cooperative thread array type execution policy, the scheduler configured to assign subsets of the cooperative thread arrays for co-execution on particular ones of the processing units based on type identifiers associated with the cooperative thread arrays and the configured policy.

### CROSS REFERENCE TO RELATED APPLICATIONS

This application claims priority and benefit under 35 U.S.C. 119(e) to U.S. Application Ser. No. 63/621,805, filed on Jan. 17, 2024, the contents of which are incorporated herein by reference in their entirety.

### BACKGROUND

The parallel processing unit such as a graphics processing unit (GPU) is a data processing device configured to execute a very large number of threads in parallel. It may operate as a coprocessor to one or more main central processing unit (CPU). Data-parallel, compute-intensive portions of applications running on the host may be off-loaded to execute on the parallel processing unit.

A portion of an application that is executed many times, but independently on different data, may be isolated into a kernel that is executed on, for example, a GPU in the form of many different parallel threads. At any given time during operation, multiple different application kernels may be co-scheduled and executing on a particular GPU.

The set of threads that executes a kernel may be configured as a grid. A grid may comprise an arrangement of cooperative thread arrays (CTAs). Some GPUs may be constructed with a scalable array of multithreaded streaming multiprocessors. When a host program invokes a kernel grid, the CTAs of the grid are enumerated and distributed to those streaming multiprocessors that have available execution capacity. The threads of a particular CTA execute concurrently on one streaming multiprocessor.

A cooperative thread array is a body of threads that execute a kernel in parallel. Each CTA thread may apply a thread identifier to determine an assigned role, assign specific input and output positions, compute addresses, and select work to perform. The thread identifier may specify the thread's coordinates within a one dimensional, two dimensional (2D), or three dimensional (3D) CTA. For example in a 3D CTA, the thread identifier may comprise three components (x, y, z) where each component ranges from zero up to the number of thread ids in the corresponding CTA dimension.

On some parallel processing units the threads within a CTA may execute in SIMT (single-instruction, multiple-thread) fashion in groups called warps. A warp is a maximal subset of threads from a single CTA that execute the same instructions at the same time. Threads within a warp may be sequentially numbered. In some implementations, a warp comprises 32 threads.

Threads within a CTA may communicate with one other. To coordinate among threads within a CTA, synchronization points may be utilized where threads suspend their execution until the execution of other or all threads in the CTA arrive at the synchronization point.

Each thread in a CTA may be configured with a private local memory, and each CTA may be configured with access to a memory shared among the threads of the CTA (but not threads in other CTAs). All threads, across the CTAs, may be configured with access to a global memory.

When a host program invokes a kernel grid, the CTAs of the grid are distributed to those of the GPU's processing units, e.g., streaming multiprocessors (SMs), that have available execution capacity. The threads of a CTA execute concurrently on a particular GPU processing unit. As CTAs complete execution and terminate, they are vacated and new CTAs are launched into execution on the vacated processing units.

Different application kernels in general exhibit different execution behavior and therefore have different resource needs. It follows that the CTAs for different kernels exhibit different (heterogeneous) execution behavior and have different resource needs. It would be technologically advantageous to exploit the heterogeneous behavior of CTAs to improve GPU execution performance.

One conventional mechanism to co-execute heterogeneous kernels is HFuse (“Automatic Horizontal Fusion for GPU Kernels”). HFuse applies a compiler to identify two kernels, one that exhibits memory-bandwidth intensive execution behavior, and one that exhibits compute-intensive execution behavior. From the source code of these two kernels, the compiler generates a new, single kernel. The CTAs (work items to execute) from this single combined kernel are allocated among the GPUs execution units (e.g., streaming multiprocessors) in some fixed ratio. Hfuse does not scale beyond scheduling work items for two different kernels. Hfuse requires a specific and constrained relationship between the two kernels, namely that one is compute-intensive and the other is memory-bandwidth intensive. HFuse also combines the kernels together in the compiler which requires access to the source code for the two kernels. HFuse is a static approach that does not take advantage of dynamic execution factors, such as kernel configuration (e.g., kernel grid dimensions and parameters) and that statically allocates processor resources between the two kernel workloads.

In general, there is a need for mechanisms providing improved and less constrained control over the co-execution of heterogeneous CTAs' execution. Absent this control, dynamic (during execution) resource oversubscription becomes more probable due to CTAs from the same kernel being assigned to the same streaming multiprocessor for co-execution. In addition to oversubscription of certain resources, other computation and memory resources of the processing elements may be underutilized without greater control of CTA co-execution.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts components of a graphics processing unit in one embodiment.

FIG. 2 depicts components of a streaming multiprocessor in one embodiment.

FIG. 3 depicts an example of CTAs in a workload execution grid.

FIG. 4 depicts an exemplary system and process to control the co-execution of heterogeneous workloads in a processor such as a GPU.

FIG. 5 depicts an example assignment of four heterogeneous kernels to streaming multiprocessors in a GPU.

FIG. 6 depicts a configuration of a hardware CTA scheduler in one embodiment.

FIG. 7 depicts an example of application logic to implement control of CTA co-execution in one embodiment.

FIG. 8 depicts a parallel processing unit 802 in accordance with one embodiment.

FIG. 9 depicts a general processing cluster 900 in accordance with one embodiment.

FIG. 10 depicts a memory partition unit 1000 in accordance with one embodiment.

FIG. 11 depicts a streaming multiprocessor 1100 in accordance with one embodiment.

FIG. 12 depicts a processing system 1200 in accordance with one embodiment.

FIG. 13 depicts an exemplary processing system 1300 in accordance with another embodiment.

### DETAILED DESCRIPTION

Mechanisms are disclosed to exploit heterogeneous kernel execution behavior to improve GPU computational performance. The mechanisms utilize control over which processing elements execute the heterogeneous CTAs from different kernels to improve co-execution. Unlike conventional approaches, the disclosed mechanisms enable control of the co-execution of heterogeneous work items on the same processing element. One implementation comprises a graphics processing unit or other data processor adapted to configure a plurality of cooperative thread arrays with different type identifiers prior to assigning the cooperative thread arrays to a plurality of processing units for execution, and a cooperative thread array scheduler configured to assign subsets of the cooperative thread arrays for co-execution on particular ones of the processing units based on the type identifiers of the cooperative thread arrays and on a resource utilization policy.

Graphics processing units may comprise hardware resources that are under- or over-utilized by particular types of application kernels. For example, some kernels may utilize matrix-processing functional units frequently, whereas others may utilize on-chip or off-chip memory bandwidth heavily. Different kernels may utilize to a lesser or greater extent different static hardware resources such as processor register space, thread execution contexts, or shared memory space.

Co-executing heterogeneous kernels having different resource requirements provides opportunities to improve processing unit utilization and thereby performance. For example, CTA work items from compute-intensive (e.g., heavy on matrix multiplication) kernels may be co-executed with CTA work items for memory bandwidth intensive kernels.

Two types of applications commonly executed on GPUs are artificial intelligence training and artificial intelligence inference. Collectively, these applications may be referred to as ‘Deep Learning’. A deep learning operator is a mathematical function (e.g., implemented in Python and compiled to code that executes as a kernel) implementing a portion of a deep learning model. A full deep learning model comprises a series of such operators that exchange values and that may be configured and represented as a graph structure. The values passed between operators are referred to as tensors, which are N-dimensional arrays (N≥1).

Co-executing multiple deep learning operations, each represented by a kernel and grid of CTAs, presents a challenge. The CTAs should be assigned for execution on processing units of the processor in a way that maximizes resource utilization. However, conventional GPU processors greedily schedule CTAs onto processing units and do not advantageously apply heterogeneous kernel behavior in the scheduling algorithms. This may lead to execution resource oversubscription when CTAs with similar resource requirements are mapped on the same processing unit.

The disclosed mechanisms enable more resource-aware co-execution of different applications or kernels within an application. The disclosed mechanisms may be implemented in manners that are largely transparent to the software instructions (code) of the application(s) themselves.

To successfully exploit heterogeneous kernel behavior for improved execution performance, mechanisms are disclosed to control where (e.g., by which streaming multiprocessor) heterogenous CTA work items from different kernels are executed on a processor, to help ensure co-execution.

The disclosed mechanisms enable applications to explicitly control and specify a policy of which kernel types (CTAs) should co-execute together on the same processing unit. The disclosed mechanisms further comprise modifications to conventional scheduling hardware to implement the kernel execution policies of applications.

In one aspect, kernel calls in application code may comprise a kernel type or atribute specifier. The kernel type may be identified by the application programmer, or generated by application compiler/profiling logic. Depending on the implementation, the kernel type/attribute specifier may be generic (e.g. “type 1”) or more functionally-specific (e.g. “TensorCore heavy”).

In another aspect, the processor is configured with a kernel co-execution policy. The policy specifies which and in what manner the kernel types are to be co-executed. One example of a policy specifies types that are permitted to co-execute on a streaming multiprocessor (e.g. “Type 1” and “Type 2”; “TensorCore-heavy” and “memory bandwidth-heavy”). The policy may also specify a limit on the number of CTAs of each type that may be co-executed per processing unit, e.g., per streaming multiprocessor.

While the application is executing as multiple kernels, the augmented hardware CTA scheduler implements the policy. The hardware scheduler keeps track of the processing unit's available resources (e.g. how many CTAs are scheduled per “type” or “plane”). The hardware scheduler applies this information to determine which CTAs are eligible to schedule for execution from the available work (from the CTAs from the application's various kernels).

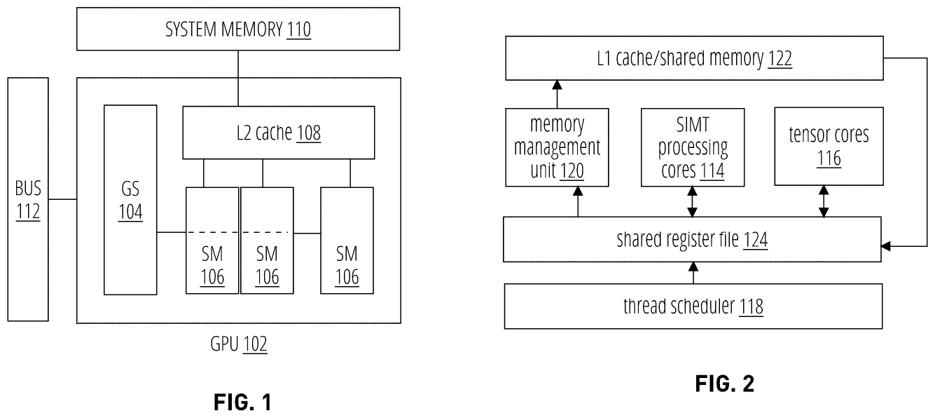

FIG. 1 depicts a simplified diagram of components of a graphics processing unit 102 in one embodiment. The graphics processing unit 102 comprises a grid scheduler 104 for a plurality of streaming multiprocessors 106. A multi-level memory system comprising a an L2 cache 108 and a system memory 110 provides storage for instructions and data utilized by the streaming multiprocessors 106 (the memory system may comprise additional levels such as an L1 cache and register file in each streaming multiprocessor 106). The graphics processing unit 102 exchanges signals with other devices using a bus 112.

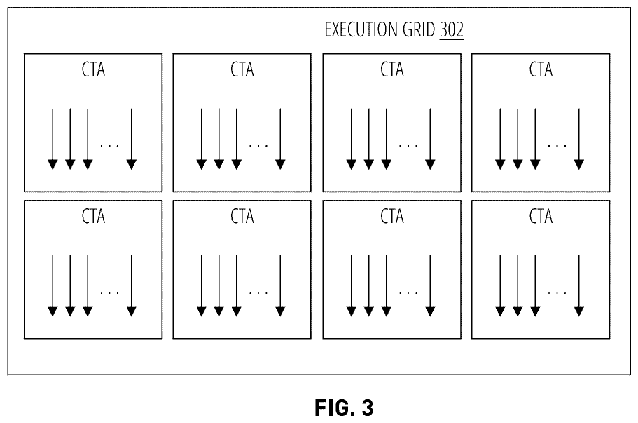

FIG. 2 depicts a simplified diagram of components of a streaming multiprocessor 106 in one embodiment. The streaming multiprocessor 106 is configured with a plurality of SIMT processing cores 114 to execute many threads in parallel in a Single Instruction Multiple Thread model. The streaming multiprocessor 106 may further comprise specialized data processing components such as tensor cores 116 optimized to perform operations (e.g., matrix math, inner products, etc.) commonly encountered in workloads such as AI training, AI inference, and graphics processing. A thread scheduler 118 is utilized to schedule the execution of many threads in parallel. The threads assigned for execution by the streaming multiprocessors 106 in a graphics processing unit 102 may be organized into an execution grid 302, e.g., as depicted in FIG. 3.

A memory management unit 120 manages the allocation of instructions and data for the cooperative thread arrays among the various levels of the memory hierarchy, including an L1 cache 122 and a shared register file 124. The shared register file 124, SIMT processing cores 114, and tensor cores 116 are execution resources shared among the many co-executing threads of the cooperative thread arrays assigned to the streaming multiprocessor 106.

The streaming multiprocessor employs a SIMT architecture to manage hundreds of threads executing different workloads. The streaming multiprocessor may map each thread to one scalar processor core. Each scalar thread may execute independently of the others with its own instruction address and register state. In some types of graphics processing units, the streaming multiprocessor creates, manages, schedules, and executes threads in warps (groups of co-executing threads, e.g., a group of 32 threads). The individual threads of a SIMT warp initially execute synchronously at the same program address but may diverge at branch points and execute independently at times, before potentially re-converging at synchronization points in their threads.

At every instruction issue time, the streaming multiprocessor selects a warp that is ready to execute and issues the next instruction to the active threads of the warp. A warp executes one common instruction at a time, so that full efficiency is realized when all threads of a warp agree on their execution path (are converged).

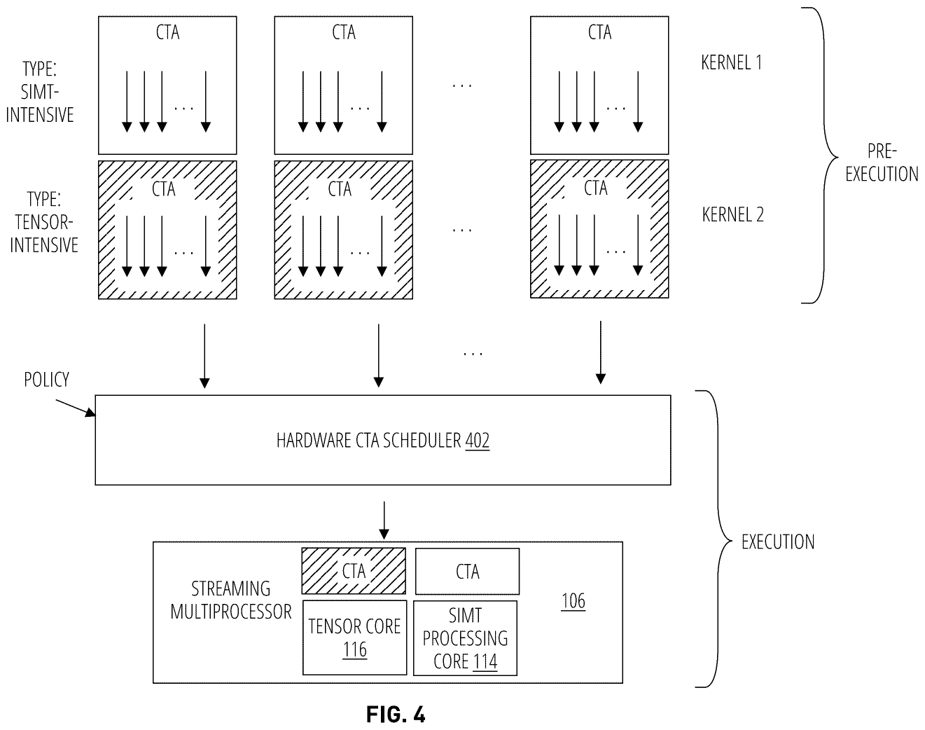

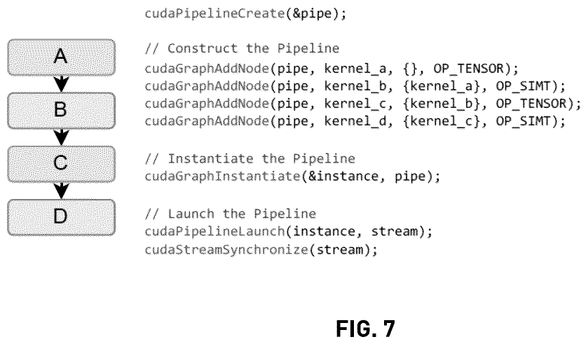

FIG. 4 depicts an exemplary system and process to control the co-execution of heterogeneous workloads in a processor such as a GPU. During a pre-execution phase, one or more kernels to execute are enhanced with or associated with a type identifier. This enhancement may be implemented, at least in part, by settings in the kernels themselves and/or to the instructions of threads comprised by the cooperative thread arrays of the kernels by a human programmer, a compiler, or a code profiler tool, for example (e.g., see FIG. 7).

The system may be configured with settings for the execution resources utilized per kernel type (e.g., in the kernel configuration along with settings for kernel resource requirements such as register and shared memory usage). In the depicted example, a configuration is formed comprising CTAs for two types of kernels, one that is SIMT-computation intensive, and the other that is tensor-processing intensive.

The hardware CTA scheduler 402 is adapted to apply these types along with configured policies for the types to allocate the execution of particular CTAs from the different kernels for co-execution across multiple streaming multiprocessors, thereby ameliorating or avoiding over-subscription of the streaming multiprocessor's execution resources (due to the different kernel types having critical resource requirements that are largely orthogonal). In the depicted example, at the execution phase, the hardware CTA scheduler 402 allocates the tensor-intensive CTAs and the SIMT-intensive CTAs among the streaming multiprocessors 106 according to availability tensor cores 116 and SIMT processing cores 114.

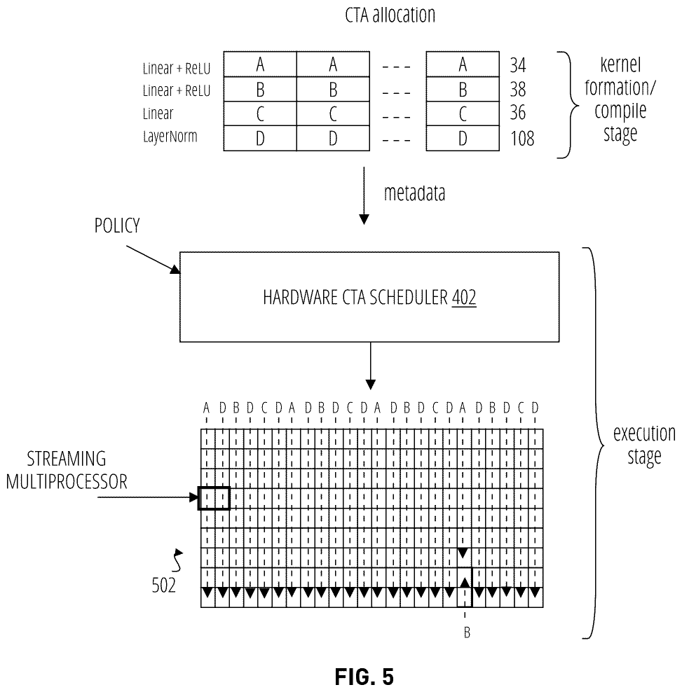

FIG. 5 depicts an example assignment of the CTA's comprised by four heterogeneous kernels (A-D) to streaming multiprocessors in a GPU.

In this example the kernels embody common workloads encountered in deep learning applications, such as linear operations, rectified linear unit (ReLU) operations, and layer normalization (LayerNorm) operations. In the depicted example, each letter represents a different kernel, and the CTAs for each kernel are typed with the functional requirements of that kernel, meaning the dominant resource type assigned to a kernel is associated with each CTA in that kernel.

Each kernel has a number of CTAs allocated to it (34, 38, 36, and 108). The hardware CTA scheduler 402 applies the kernel types and a configured policy for executing those kernel types to assign combinations of the CTAs to individual streaming multiprocessors.

In execution resource terms, the LayerNorm kernel is SIMT-intensive and the Linear and Linear+ kernels are tensor core intensive. Thus the LayerNorm and Linear/Linear+ReLU kernels have substantially orthogonal resource needs. The CTA hardware CTA scheduler 402 therefore schedules combinations of the LayerNorm and Linear/Linear+ReLU CTAs for co-execution on particular ones of the available streaming multiprocessors. In the depicted example the scheduling allocation of CTAs to streaming multiprocessors is implemented as an execution grid 502.

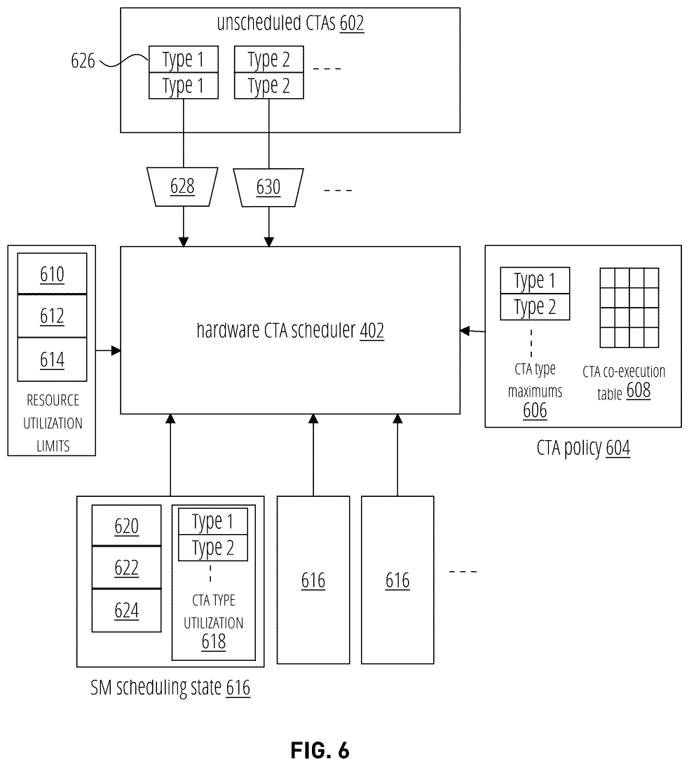

FIG. 6 depicts a CTA scheduler configuration in one embodiment. The symmetric streaming multiprocessor on which a particular unscheduled CTA context 602 is scheduled is based on a type identifier associated with the particular CTA, and on a configured CTA scheduling policy 604 for the hardware CTA scheduler 402. The CTA scheduling policy 604 comprises two components: (1) a maximum number M of CTAs per type allowed to execute on a streaming multiprocessor (CTA type maximums 606, M>0), and (2) permitted combinations of CTA types that may co-execute on a streaming multiprocessor as embodied for example in a programmable CTA co-execution table 608 of permissible CTA co-execution types. The hardware CTA scheduler 402 may be configured with additional resource limits such as register file utilization maximums 610, scratchpad memory utilization maximums 612, and CTA contexts maximums 614 per streaming multiprocessor.

The streaming multiprocessor scheduling state 616 may be augmented to include a number of CTAs of each type that have been scheduled for execution (CTA type utilizations 618). The streaming multiprocessor scheduling state 616 may also be configured to track register file utilization 620, scratchpad memory utilization 622, and CTA context utilization 624 in the streaming multiprocessor.

At least one type specifier may be associated with each CTA. The type(s) associated with a CTA may be inherited from the kernel from which the CTA is derived. In one embodiment, the hardware CTA scheduler 402 assigns CTAs for execution on particular streaming multiprocessors based on the CTA types and a number of configured policy factors:
The maximum number of CTAs, per type, that may be assigned to a streaming multiprocessor (CTA type maximums 606), e.g., 0 to N>0.
The permitted combinations of CTA types that can co-execute on a streaming multiprocessor (CTA co-execution table 608). More generally, the CTA scheduling policy 604 may comprise any associative logic that defines permitted co-executions between CTA types, a table structure being one such possible associative logic implementation.
The number of CTAs of each type scheduled for execution on each particular streaming multiprocessor (CTA type utilization 618).

The unscheduled CTA contexts 602 may be organized into scheduling queues 626, with each scheduling queue 626 comprising CTAs of one particular type. CTAs may be scheduled from the queues on a first-in-first-out basis.

During the execution of one or more applications the hardware CTA scheduler 402 implements the configured CTA scheduling policy 604. The hardware CTA scheduler 402 tracks the streaming multiprocessors' available resources and how many CTAs are scheduled per type (CTA type utilization 618) on each streaming multiprocessor. The hardware CTA scheduler 402 applies these settings to make co-execution assignments of different types of CTAs from the unscheduled CTA contexts 602 to particular streaming multiprocessors.

The hardware CTA scheduler 402 may comprise a grid scheduler configured to utilize type identifiers configured into kernel call headers (see FIG. 7). To enable CTAs of different types that are permitted by the CTA scheduling policy 604 to co-execute on the streaming multiprocessors, arbiters 628, 630 . . . may be provided for each kernel/CTA type. The arbiters 628, 630 . . . enable the hardware CTA scheduler 402 to effectively pair different CTA types for execution together on a particular streaming multiprocessor by enabling the separate and independent dispatch of unscheduled CTA contexts 602 of different types to the same streaming multiprocessor. When a new kernel arrives at the hardware CTA scheduler 402 for execution, the appropriate arbiter is selected based on the type to admit the CTAs of the kernel for execution scheduling. CTA scheduling then proceeds according to the scheduling algorithm implemented by the hardware CTA scheduler 402 (e.g., round-robin across the streaming multiprocessors of the GPU), checking the occupancy of each streaming multiprocessor or other processing unit for availability to receive a CTA dispatch.

To more fully utilize resources across multiple processing units—for example, to more fully and efficiently utilize tensor cores 116 and SIMT processing cores 114 simultaneously—the grid scheduler 104 may be configured to generate spatial pipelines of kernels.

A spatial pipeline configures a collection of kernels and constrains the collection to being coresident on the processor. The application comprising the kernels is configured to limit the number of CTAs launched per kernel to ensure coresidency is possible.

In one embodiment, a kernel call from the application embeds a type specifier in the call. The kernel type specifier may be provided by the application programmer or generated by a compiler or code profiling tool. The processor is also configured with a co-execution policy that defines how CTAs that inherit particular types from kernels should be co-executed.

In one example, a GPU system is configured with two kernel types and a policy that enables these two types to co-execute on the GPU's streaming multiprocessors (e.g. “Type 1” and “Type 2”). The policy may also specify how many CTAs of each type are allowed to execute on each streaming multiprocessor. With the policy defined, the GPU is configured to execute in the mode specified by the policy.

FIG. 7 depicts logic in the form of application instructions that configure a spatial pipeline. Data dependencies in the form of a linear graph are defined. Kernels are configured as nodes of the graph with a property that specifies a primary type of execution resource they utilize, which in this example are either SIMT cores or tensor cores.

The linear graph (pipeline) is instantiated and launched for execution scheduling. The application may also configure the hardware CTA scheduler with a policy specifying, inter alia, the maximum numbers of CTAs of the various types that may be scheduled per streaming multiprocessor, and/or the allowable types of CTAs that may be co-executed on a streaming multiprocessor. In some embodiments, the policy settings may be statically configured into the hardware CTA scheduler, so that they apply to all workloads and cannot be changed programmatically.

CTAs in a spatially pipelined kernel may be launched with parameters to control the order of work and synchronize with upstream producer CTAs and downstream consumer CTAs. To help ensure a guarantee of full occupancy, the launch order of the CTAs is enabled to be flexible, with the CTA type and co-execution needs and opportunities configured as the primary launch consideration.

Type specifiers may be associated with kernels upon launch for execution. The hardware scheduler may be configured with policies for scheduling the various kernel types. The spatial pipeline may be configured such that a threshold limit of CTAs may execute at a given time. This may result in the scheduling queues being full at the start of scheduling but being empty during execution. The spatial pipeline specifies the types of the CTAs that should be scheduled to execute together. On platforms utilizing graphics processing units made by Nvidia Corp, kernels may comprise a CudaStreamSynchronize function call as a terminus of a spatial pipeline to cause the graphics processing unit to wait for all spatial pipeline kernels to complete execution.

The mechanisms disclosed herein may be implemented on computing devices utilizing one or more graphics processing unit (GPU) and/or general purpose data processor (e.g., a ‘central processing unit’ or CPU). Exemplary architectures will now be described that may be configured with the mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

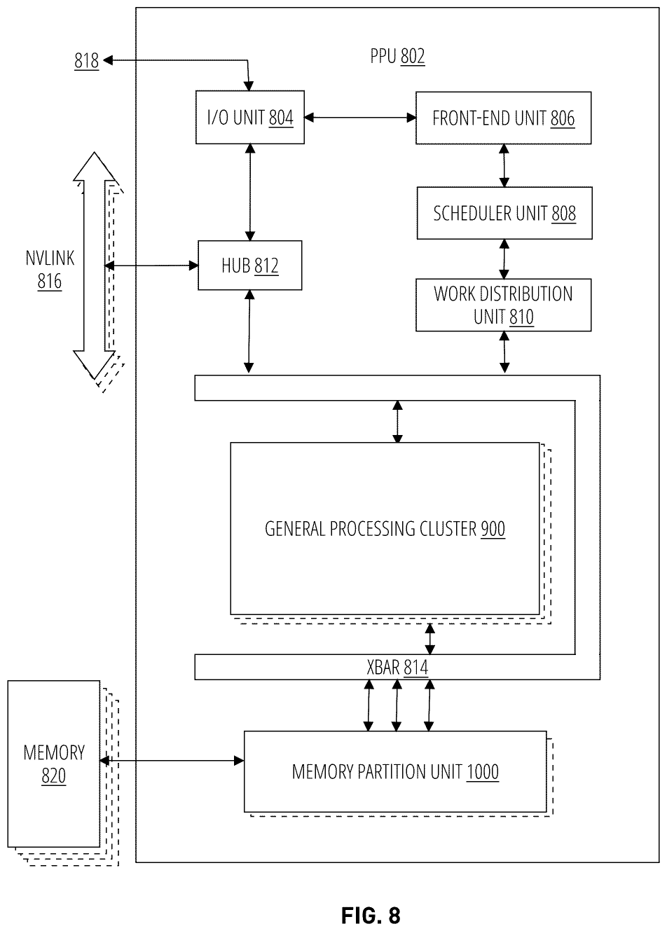

FIG. 8 depicts a parallel processing unit 802, in accordance with an embodiment. In an embodiment, the parallel processing unit 802 is a multi-threaded processor that is implemented on one or more integrated circuit devices. The parallel processing unit 802 is a latency hiding architecture designed to process many threads in parallel. A thread (e.g., a thread of execution) is an instantiation of a set of instructions configured to be executed by the parallel processing unit 802. In an embodiment, the parallel processing unit 802 is a graphics processing unit (GPU) configured to implement a graphics rendering pipeline and machine learning training and inference. In other embodiments, the parallel processing unit 802 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 802 modules may be configured to accelerate thousands of High Performance Computing (HPC), data center, and machine learning applications. The parallel processing unit 802 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 8, the parallel processing unit 802 includes an I/O unit 804, a front-end unit 806, a scheduler unit 808, a work distribution unit 810, a hub 812, a crossbar 814, one or more general processing cluster 900 modules, and one or more memory partition unit 1000 modules. The parallel processing unit 802 may be connected to a host processor or other parallel processing unit 802 modules via one or more high-speed NVLink 816 interconnects. The parallel processing unit 802 may be connected to a host processor or other peripheral devices via an interconnect 818. The parallel processing unit 802 may also be connected to a local memory comprising a number of memory 820 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 820 may comprise logic to configure the parallel processing unit 802 to carry out aspects of the techniques disclosed herein.

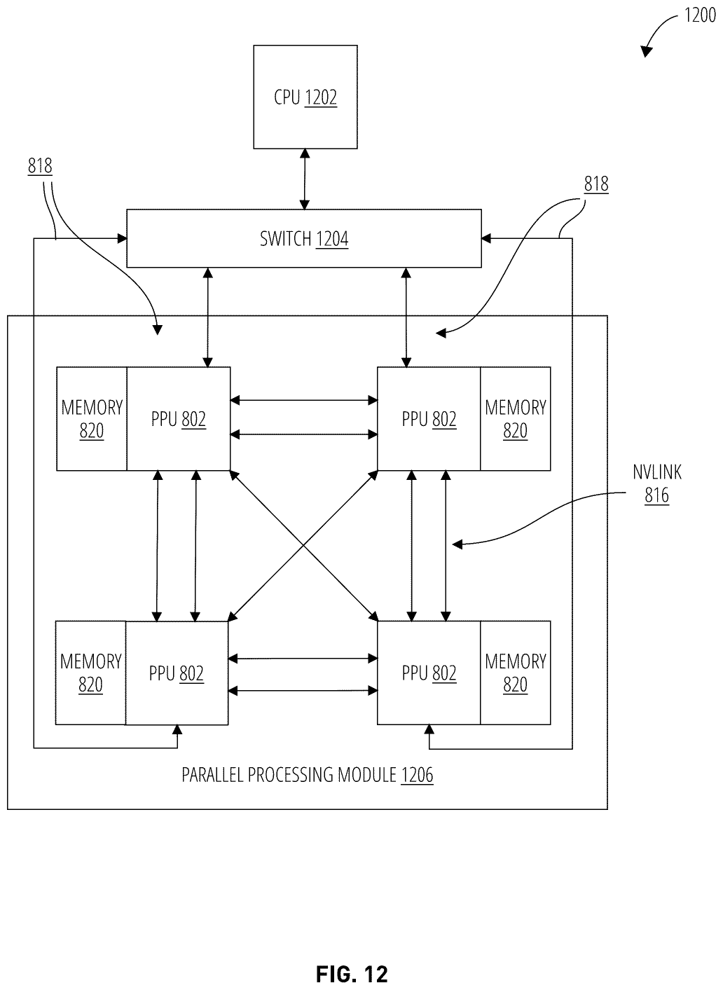

The NVLink 816 interconnect enables systems to scale and include one or more parallel processing unit 802 modules combined with one or more CPUs, supports cache coherence between the parallel processing unit 802 modules and CPUs, and CPU mastering. Data and/or commands may be transmitted by the NVLink 816 through the hub 812 to/from other units of the parallel processing unit 802 such as one or more copy engines, a video encoder, a video decoder, a power management unit, etc. (not explicitly shown). The NVLink 816 is described in more detail in conjunction with FIG. 12.

The I/O unit 804 is configured to transmit and receive communications (e.g., commands, data, etc.) from a host processor (not shown) over the interconnect 818. The I/O unit 804 may communicate with the host processor directly via the interconnect 818 or through one or more intermediate devices such as a memory bridge. In an embodiment, the I/O unit 804 may communicate with one or more other processors, such as one or more parallel processing unit 802 modules via the interconnect 818. In an embodiment, the I/O unit 804 implements a Peripheral Component Interconnect Express (PCIe) interface for communications over a PCIe bus and the interconnect 818 is a PCIe bus. In alternative embodiments, the I/O unit 804 may implement other types of well-known interfaces for communicating with external devices.

The I/O unit 804 decodes packets received via the interconnect 818. In an embodiment, the packets represent commands configured to cause the parallel processing unit 802 to perform various operations. The I/O unit 804 transmits the decoded commands to various other units of the parallel processing unit 802 as the commands may specify. For example, some commands may be transmitted to the front-end unit 806. Other commands may be transmitted to the hub 812 or other units of the parallel processing unit 802 such as one or more copy engines, a video encoder, a video decoder, a power management unit, etc. (not explicitly shown). In other words, the I/O unit 804 is configured to route communications between and among the various logical units of the parallel processing unit 802.

In an embodiment, a program executed by the host processor encodes a command stream in a buffer that provides workloads to the parallel processing unit 802 for processing. A workload may comprise several instructions and data to be processed by those instructions. The buffer is a region in a memory that is accessible (e.g., read/write) by both the host processor and the parallel processing unit 802. For example, the I/O unit 804 may be configured to access the buffer in a system memory connected to the interconnect 818 via memory requests transmitted over the interconnect 818. In an embodiment, the host processor writes the command stream to the buffer and then transmits a pointer to the start of the command stream to the parallel processing unit 802. The front-end unit 806 receives pointers to one or more command streams. The front-end unit 806 manages the one or more streams, reading commands from the streams and forwarding commands to the various units of the parallel processing unit 802.

The front-end unit 806 is coupled to a scheduler unit 808 that configures the various general processing cluster 900 modules to process tasks defined by the one or more streams. The scheduler unit 808 is configured to track state information related to the various tasks managed by the scheduler unit 808. The state may indicate which general processing cluster 900 a task is assigned to, whether the task is active or inactive, a priority level associated with the task, and so forth. The scheduler unit 808 manages the execution of a plurality of tasks on the one or more general processing cluster 900 modules.

The scheduler unit 808 is coupled to a work distribution unit 810 that is configured to dispatch tasks for execution on the general processing cluster 900 modules. The work distribution unit 810 may track a number of scheduled tasks received from the scheduler unit 808. In an embodiment, the work distribution unit 810 manages a pending task pool and an active task pool for each of the general processing cluster 900 modules. The pending task pool may comprise a number of slots (e.g., 32 slots) that contain tasks assigned to be processed by a particular general processing cluster 900. The active task pool may comprise a number of slots (e.g., 4 slots) for tasks that are actively being processed by the general processing cluster 900 modules. As a general processing cluster 900 finishes the execution of a task, that task is evicted from the active task pool for the general processing cluster 900 and one of the other tasks from the pending task pool is selected and scheduled for execution on the general processing cluster 900. If an active task has been idle on the general processing cluster 900, such as while waiting for a data dependency to be resolved, then the active task may be evicted from the general processing cluster 900 and returned to the pending task pool while another task in the pending task pool is selected and scheduled for execution on the general processing cluster 900.

The work distribution unit 810 communicates with the one or more general processing cluster 900 modules via crossbar 814. The crossbar 814 is an interconnect network that couples many of the units of the parallel processing unit 802 to other units of the parallel processing unit 802. For example, the crossbar 814 may be configured to couple the work distribution unit 810 to a particular general processing cluster 900. Although not shown explicitly, one or more other units of the parallel processing unit 802 may also be connected to the crossbar 814 via the hub 812.

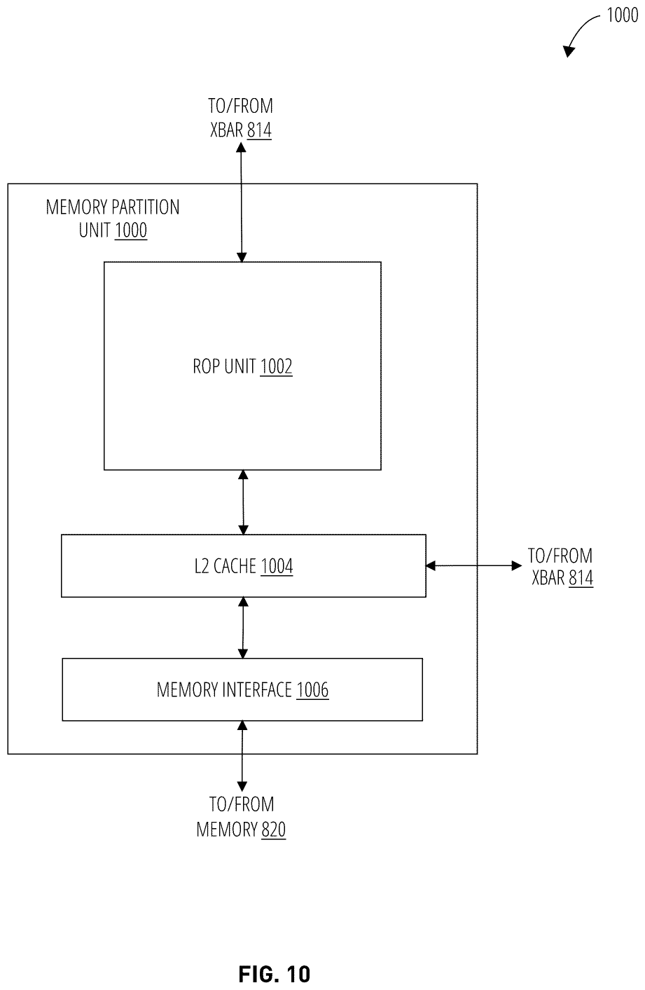

The tasks are managed by the scheduler unit 808 and dispatched to a general processing cluster 900 by the work distribution unit 810. The general processing cluster 900 is configured to process the task and generate results. The results may be consumed by other tasks within the general processing cluster 900, routed to a different general processing cluster 900 via the crossbar 814, or stored in the memory 820. The results can be written to the memory 820 via the memory partition unit 1000 modules, which implement a memory interface for reading and writing data to/from the memory 820. The results can be transmitted to another parallel processing unit 802 or CPU via the NVLink 816. In an embodiment, the parallel processing unit 802 includes a number U of memory partition unit 1000 modules that is equal to the number of separate and distinct memory 820 devices coupled to the parallel processing unit 802. A memory partition unit 1000 will be described in more detail below in conjunction with FIG. 10.

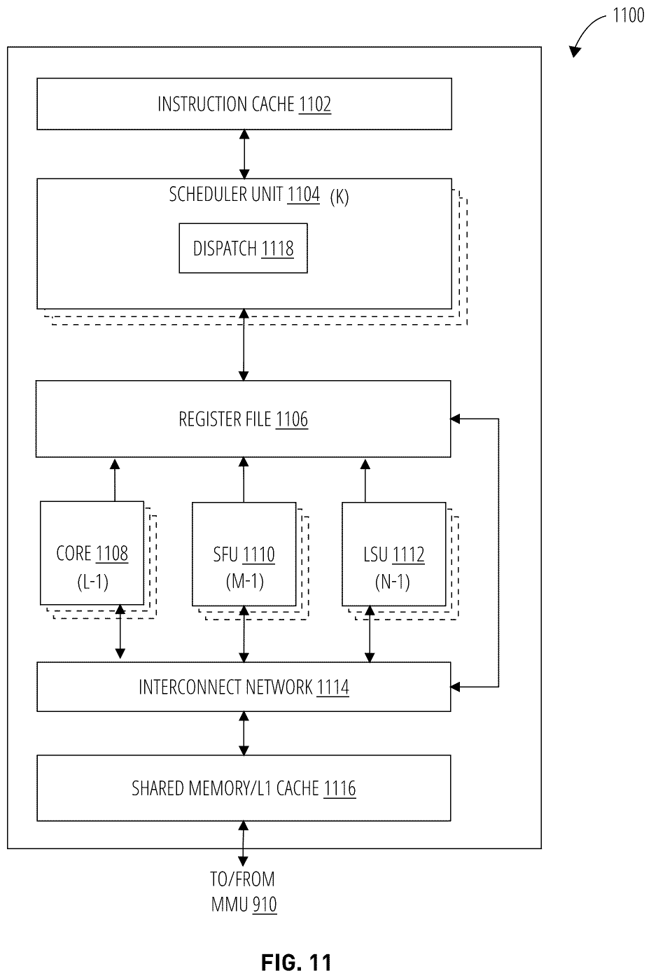

In an embodiment, a host processor executes a driver kernel that implements an application programming interface (API) that enables one or more applications executing on the host processor to schedule operations for execution on the parallel processing unit 802. In an embodiment, multiple compute applications are simultaneously executed by the parallel processing unit 802 and the parallel processing unit 802 provides isolation, quality of service (QoS), and independent address spaces for the multiple compute applications. An application may generate instructions (e.g., API calls) that cause the driver kernel to generate one or more tasks for execution by the parallel processing unit 802. The driver kernel outputs tasks to one or more streams being processed by the parallel processing unit 802. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 11.

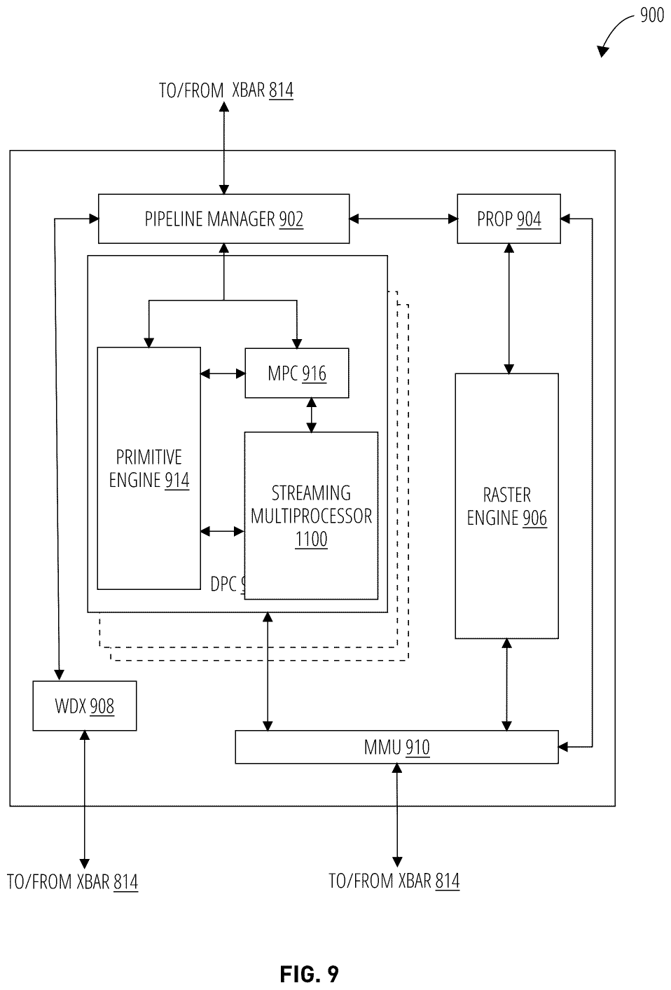

FIG. 9 depicts a general processing cluster 900 of the parallel processing unit 802 of FIG. 8, in accordance with an embodiment. As shown in FIG. 9, each general processing cluster 900 includes a number of hardware units for processing tasks. In an embodiment, each general processing cluster 900 includes a pipeline manager 902, a pre-raster operations unit 904, a raster engine 906, a work distribution crossbar 908, a memory management unit 910, and one or more data processing cluster 912. It will be appreciated that the general processing cluster 900 of FIG. 9 may include other hardware units in lieu of or in addition to the units shown in FIG. 9.

In an embodiment, the operation of the general processing cluster 900 is controlled by the pipeline manager 902. The pipeline manager 902 manages the configuration of the one or more data processing cluster 912 modules for processing tasks allocated to the general processing cluster 900. In an embodiment, the pipeline manager 902 may configure at least one of the one or more data processing cluster 912 modules to implement at least a portion of a graphics rendering pipeline. For example, a data processing cluster 912 may be configured to execute a vertex shader program on the programmable streaming multiprocessor 1100. The pipeline manager 902 may also be configured to route packets received from the work distribution unit 810 to the appropriate logical units within the general processing cluster 900. For example, some packets may be routed to fixed function hardware units in the pre-raster operations unit 904 and/or raster engine 906 while other packets may be routed to the data processing cluster 912 modules for processing by the primitive engine 914 or the streaming multiprocessor 1100. In an embodiment, the pipeline manager 902 may configure at least one of the one or more data processing cluster 912 modules to implement a neural network model and/or a computing pipeline.

The pre-raster operations unit 904 is configured to route data generated by the raster engine 906 and the data processing cluster 912 modules to a Raster Operations (ROP) unit, described in more detail in conjunction with FIG. 10. The pre-raster operations unit 904 may also be configured to perform optimizations for color blending, organize pixel data, perform address translations, and the like.

The raster engine 906 includes a number of fixed function hardware units configured to perform various raster operations. In an embodiment, the raster engine 906 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 906 comprises fragments to be processed, for example, by a fragment shader implemented within a data processing cluster 912.

Each data processing cluster 912 included in the general processing cluster 900 includes an M-pipe controller 916, a primitive engine 914, and one or more streaming multiprocessor 1100 modules. The M-pipe controller 916 controls the operation of the data processing cluster 912, routing packets received from the pipeline manager 902 to the appropriate units in the data processing cluster 912. For example, packets associated with a vertex may be routed to the primitive engine 914, which is configured to fetch vertex attributes associated with the vertex from the memory 820. In contrast, packets associated with a shader program may be transmitted to the streaming multiprocessor 1100.

The streaming multiprocessor 1100 comprises a programmable streaming processor that is configured to process tasks represented by a number of threads. Each streaming multiprocessor 1100 is multi-threaded and configured to execute a plurality of threads (e.g., 32 threads) from a particular group of threads concurrently. In an embodiment, the streaming multiprocessor 1100 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1100 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1100 will be described in more detail below in conjunction with FIG. 11.

The memory management unit 910 provides an interface between the general processing cluster 900 and the memory partition unit 1000. The memory management unit 910 may provide translation of virtual addresses into physical addresses, memory protection, and arbitration of memory requests. In an embodiment, the memory management unit 910 provides one or more translation lookaside buffers (TLBs) for performing translation of virtual addresses into physical addresses in the memory 820.

FIG. 10 depicts a memory partition unit 1000 of the parallel processing unit 802 of FIG. 8, in accordance with an embodiment. As shown in FIG. 10, the memory partition unit 1000 includes a raster operations unit 1002, a level two cache 1004, and a memory interface 1006. The memory interface 1006 is coupled to the memory 820. Memory interface 1006 may implement 32, 64, 128, 1024-bit data buses, or the like, for high-speed data transfer. In an embodiment, the parallel processing unit 802 incorporates U memory interface 1006 modules, one memory interface 1006 per pair of memory partition unit 1000 modules, where each pair of memory partition unit 1000 modules is connected to a corresponding memory 820 device. For example, parallel processing unit 802 may be connected to up to Y memory 820 devices, such as high bandwidth memory stacks or graphics double-data-rate, version 5, synchronous dynamic random access memory, or other types of persistent storage.

In an embodiment, the memory interface 1006 implements an HBM2 memory interface and Y equals half U. In an embodiment, the HBM2 memory stacks are located on the same physical package as the parallel processing unit 802, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 820 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 802 modules process very large datasets and/or run applications for extended periods.

In an embodiment, the parallel processing unit 802 implements a multi-level memory hierarchy. In an embodiment, the memory partition unit 1000 supports a unified memory to provide a single unified virtual address space for CPU and parallel processing unit 802 memory, enabling data sharing between virtual memory systems. In an embodiment the frequency of accesses by a parallel processing unit 802 to memory located on other processors is traced to ensure that memory pages are moved to the physical memory of the parallel processing unit 802 that is accessing the pages more frequently. In an embodiment, the NVLink 816 supports address translation services allowing the parallel processing unit 802 to directly access a CPU's page tables and providing full access to CPU memory by the parallel processing unit 802.

In an embodiment, copy engines transfer data between multiple parallel processing unit 802 modules or between parallel processing unit 802 modules and CPUs. The copy engines can generate page faults for addresses that are not mapped into the page tables. The memory partition unit 1000 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 820 or other system memory may be fetched by the memory partition unit 1000 and stored in the level two cache 1004, which is located on-chip and is shared between the various general processing cluster 900 modules. As shown, each memory partition unit 1000 includes a portion of the level two cache 1004 associated with a corresponding memory 820 device. Lower level caches may then be implemented in various units within the general processing cluster 900 modules. For example, each of the streaming multiprocessor 1100 modules may implement an L1 cache. The L1 cache is private memory that is dedicated to a particular streaming multiprocessor 1100. Data from the level two cache 1004 may be fetched and stored in each of the L1 caches for processing in the functional units of the streaming multiprocessor 1100 modules. The level two cache 1004 is coupled to the memory interface 1006 and the crossbar 814.

The raster operations unit 1002 performs graphics raster operations related to pixel color, such as color compression, pixel blending, and the like. The raster operations unit 1002 also implements depth testing in conjunction with the raster engine 906, receiving a depth for a sample location associated with a pixel fragment from the culling engine of the raster engine 906. The depth is tested against a corresponding depth in a depth buffer for a sample location associated with the fragment. If the fragment passes the depth test for the sample location, then the raster operations unit 1002 updates the depth buffer and transmits a result of the depth test to the raster engine 906. It will be appreciated that the number of partition memory partition unit 1000 modules may be different than the number of general processing cluster 900 modules and, therefore, each raster operations unit 1002 may be coupled to each of the general processing cluster 900 modules. The raster operations unit 1002 tracks packets received from the different general processing cluster 900 modules and determines which general processing cluster 900 that a result generated by the raster operations unit 1002 is routed to through the crossbar 814. Although the raster operations unit 1002 is included within the memory partition unit 1000 in FIG. 10, in other embodiment, the raster operations unit 1002 may be outside of the memory partition unit 1000. For example, the raster operations unit 1002 may reside in the general processing cluster 900 or another unit.

FIG. 11 illustrates the streaming multiprocessor 1100 of FIG. 9, in accordance with an embodiment. As shown in FIG. 11, the streaming multiprocessor 1100 includes an instruction cache 1102, one or more scheduler unit 1104 modules (e.g., such as scheduler unit 808), a register file 1106, one or more processing core 1108 modules, one or more special function unit 1110 modules, one or more load/store unit 1112 modules, an interconnect network 1114, and a shared memory/L1 cache 1116.

As described above, the work distribution unit 810 dispatches tasks for execution on the general processing cluster 900 modules of the parallel processing unit 802. The tasks are allocated to a particular data processing cluster 912 within a general processing cluster 900 and, if the task is associated with a shader program, the task may be allocated to a streaming multiprocessor 1100. The scheduler unit 808 receives the tasks from the work distribution unit 810 and manages instruction scheduling for one or more thread blocks assigned to the streaming multiprocessor 1100. The scheduler unit 1104 schedules thread blocks for execution as warps of parallel threads, where each thread block is allocated at least one warp. In an embodiment, each warp executes 32 threads. The scheduler unit 1104 may manage a plurality of different thread blocks, allocating the warps to the different thread blocks and then dispatching instructions from the plurality of different cooperative groups to the various functional units (e.g., core 1108 modules, special function unit 1110 modules, and load/store unit 1112 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1118 unit is configured within the scheduler unit 1104 to transmit instructions to one or more of the functional units. In one embodiment, the scheduler unit 1104 includes two dispatch 1118 units that enable two different instructions from the same warp to be dispatched during each clock cycle. In alternative embodiments, each scheduler unit 1104 may include a single dispatch 1118 unit or additional dispatch 1118 units.

Each streaming multiprocessor 1100 includes a register file 1106 that provides a set of registers for the functional units of the streaming multiprocessor 1100. In an embodiment, the register file 1106 is divided between each of the functional units such that each functional unit is allocated a dedicated portion of the register file 1106. In another embodiment, the register file 1106 is divided between the different warps being executed by the streaming multiprocessor 1100. The register file 1106 provides temporary storage for operands connected to the data paths of the functional units.

Each streaming multiprocessor 1100 comprises L processing core 1108 modules. In an embodiment, the streaming multiprocessor 1100 includes a large number (e.g., 128, etc.) of distinct processing core 1108 modules. Each core 1108 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1108 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1108 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1100 also comprises M special function unit 1110 modules that perform special functions (e.g., attribute evaluation, reciprocal square root, and the like). In an embodiment, the special function unit 1110 modules may include a tree traversal unit configured to traverse a hierarchical tree data structure. In an embodiment, the special function unit 1110 modules may include texture unit configured to perform texture map filtering operations. In an embodiment, the texture units are configured to load texture maps (e.g., a 2D array of texels) from the memory 820 and sample the texture maps to produce sampled texture values for use in shader programs executed by the streaming multiprocessor 1100. In an embodiment, the texture maps are stored in the shared memory/L1 cache 1116. The texture units implement texture operations such as filtering operations using mip-maps (e.g., texture maps of varying levels of detail). In an embodiment, each streaming multiprocessor 1100 includes two texture units.

Each streaming multiprocessor 1100 also comprises N load/store unit 1112 modules that implement load and store operations between the shared memory/L1 cache 1116 and the register file 1106. Each streaming multiprocessor 1100 includes an interconnect network 1114 that connects each of the functional units to the register file 1106 and the load/store unit 1112 to the register file 1106 and shared memory/L1 cache 1116. In an embodiment, the interconnect network 1114 is a crossbar that can be configured to connect any of the functional units to any of the registers in the register file 1106 and connect the load/store unit 1112 modules to the register file 1106 and memory locations in shared memory/L1 cache 1116.

The shared memory/L1 cache 1116 is an array of on-chip memory that allows for data storage and communication between the streaming multiprocessor 1100 and the primitive engine 914 and between threads in the streaming multiprocessor 1100. In an embodiment, the shared memory/L1 cache 1116 comprises 128 KB of storage capacity and is in the path from the streaming multiprocessor 1100 to the memory partition unit 1000. The shared memory/L1 cache 1116 can be used to cache reads and writes. One or more of the shared memory/L1 cache 1116, level two cache 1004, and memory 820 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1116 enables the shared memory/L1 cache 1116 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 8, are bypassed, creating a much simpler programming model. In the general purpose parallel computation configuration, the work distribution unit 810 assigns and distributes blocks of threads directly to the data processing cluster 912 modules. The threads in a block execute the same program, using a unique thread ID in the calculation to ensure each thread generates unique results, using the streaming multiprocessor 1100 to execute the program and perform calculations, shared memory/L1 cache 1116 to communicate between threads, and the load/store unit 1112 to read and write global memory through the shared memory/L1 cache 1116 and the memory partition unit 1000. When configured for general purpose parallel computation, the streaming multiprocessor 1100 can also write commands that the scheduler unit 808 can use to launch new work on the data processing cluster 912 modules.

The parallel processing unit 802 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 802 is embodied on a single semiconductor substrate. In another embodiment, the parallel processing unit 802 is included in a system-on-a-chip (SoC) along with one or more other devices such as additional parallel processing unit 802 modules, the memory 820, a reduced instruction set computer (RISC) CPU, a memory management unit (MMU), a digital-to-analog converter (DAC), and the like.

In an embodiment, the parallel processing unit 802 may be included on a graphics card that includes one or more memory devices. The graphics card may be configured to interface with a PCIe slot on a motherboard of a desktop computer. In yet another embodiment, the parallel processing unit 802 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 12 is a conceptual diagram of a processing system 1200 implemented using the parallel processing unit 802 of FIG. 8, in accordance with an embodiment. The processing system 1200 includes a central processing unit 1202, switch 1204, and multiple parallel processing unit 802 modules each and respective memory 820 modules. The NVLink 816 provides high-speed communication links between each of the parallel processing unit 802 modules. Although a particular number of NVLink 816 and interconnect 818 connections are illustrated in FIG. 12, the number of connections to each parallel processing unit 802 and the central processing unit 1202 may vary. The switch 1204 interfaces between the interconnect 818 and the central processing unit 1202. The parallel processing unit 802 modules, memory 820 modules, and NVLink 816 connections may be situated on a single semiconductor platform to form a parallel processing module 1206. In an embodiment, the switch 1204 supports two or more protocols to interface between various different connections and/or links.

In another embodiment (not shown), the NVLink 816 provides one or more high-speed communication links between each of the parallel processing unit modules (parallel processing unit 802, parallel processing unit 802, parallel processing unit 802, and parallel processing unit 802) and the central processing unit 1202 and the switch 1204 interfaces between the interconnect 818 and each of the parallel processing unit modules. The parallel processing unit modules, memory 820 modules, and interconnect 818 may be situated on a single semiconductor platform to form a parallel processing module 1206. In yet another embodiment (not shown), the interconnect 818 provides one or more communication links between each of the parallel processing unit modules and the central processing unit 1202 and the switch 1204 interfaces between each of the parallel processing unit modules using the NVLink 816 to provide one or more high-speed communication links between the parallel processing unit modules. In another embodiment (not shown), the NVLink 816 provides one or more high-speed communication links between the parallel processing unit modules and the central processing unit 1202 through the switch 1204. In yet another embodiment (not shown), the interconnect 818 provides one or more communication links between each of the parallel processing unit modules directly. One or more of the NVLink 816 high-speed communication links may be implemented as a physical NVLink interconnect or either an on-chip or on-die interconnect using the same protocol as the NVLink 816.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1206 may be implemented as a circuit board substrate and each of the parallel processing unit modules and/or memory 820 modules may be packaged devices. In an embodiment, the central processing unit 1202, switch 1204, and the parallel processing module 1206 are situated on a single semiconductor platform.

In an embodiment, the signaling rate of each NVLink 816 is 20 to 25 Gigabits/second and each parallel processing unit module includes six NVLink 816 interfaces (as shown in FIG. 12, five NVLink 816 interfaces are included for each parallel processing unit module). Each NVLink 816 provides a data transfer rate of 25 Gigabytes/second in each direction, with six links providing 300 Gigabytes/second. The NVLink 816 can be used exclusively for PPU-to-PPU communication as shown in FIG. 12, or some combination of PPU-to-PPU and PPU-to-CPU, when the central processing unit 1202 also includes one or more NVLink 816 interfaces.

In an embodiment, the NVLink 816 allows direct load/store/atomic access from the central processing unit 1202 to each parallel processing unit module's memory 820. In an embodiment, the NVLink 816 supports coherency operations, allowing data read from the memory 820 modules to be stored in the cache hierarchy of the central processing unit 1202, reducing cache access latency for the central processing unit 1202. In an embodiment, the NVLink 816 includes support for Address Translation Services (ATS), enabling the parallel processing unit module to directly access page tables within the central processing unit 1202. One or more of the NVLink 816 may also be configured to operate in a low-power mode.

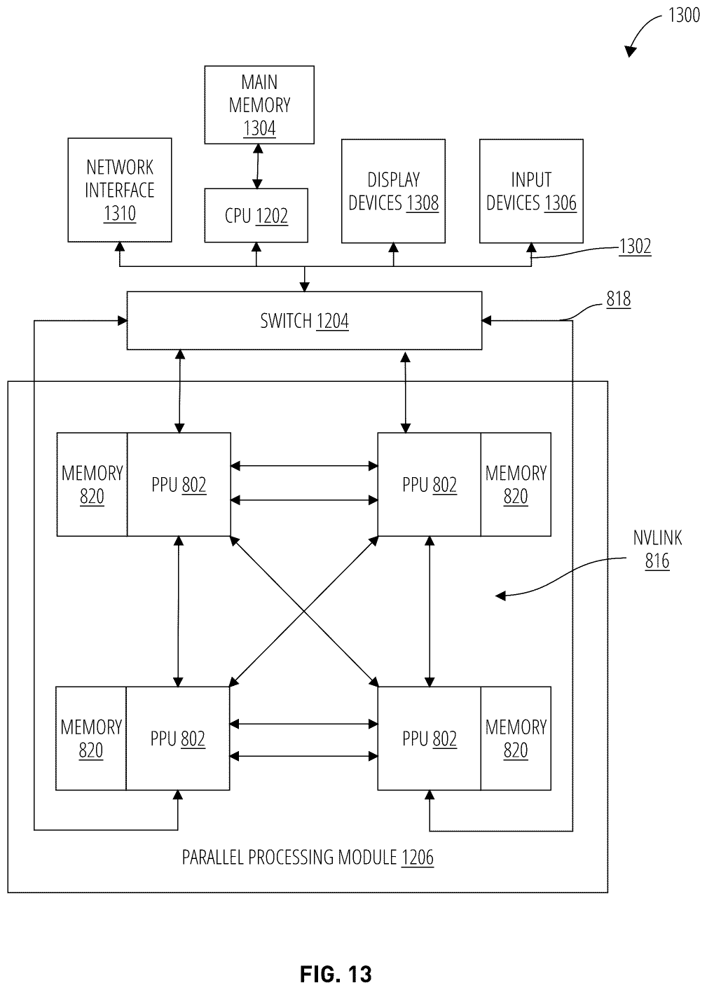

FIG. 13 depicts an exemplary processing system 1300 in which the various architecture and/or functionality of the various previous embodiments may be implemented. As shown, an exemplary processing system 1300 is provided including at least one central processing unit 1202 that is connected to a communications bus 1302. The communication communications bus 1302 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1300 also includes a main memory 1304. Control logic (software) and data are stored in the main memory 1304 which may take the form of random access memory (RAM).

The exemplary processing system 1300 also includes input devices 1306, the parallel processing module 1206, and display devices 1308, e.g. a conventional CRT (cathode ray tube), LCD (liquid crystal display), LED (light emitting diode), plasma display or the like. User input may be received from the input devices 1306, e.g., keyboard, mouse, touchpad, microphone, and the like. Each of the foregoing modules and/or devices may even be situated on a single semiconductor platform to form the exemplary processing system 1300. Alternately, the various modules may also be situated separately or in various combinations of semiconductor platforms per the desires of the user.

Further, the exemplary processing system 1300 may be coupled to a network (e.g., a telecommunications network, local area network (LAN), wireless network, wide area network (WAN) such as the Internet, peer-to-peer network, cable network, or the like) through a network interface 1310 for communication purposes.

The exemplary processing system 1300 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1304 and/or the secondary storage. Such computer programs, when executed, enable the exemplary processing system 1300 to perform various functions. The main memory 1304, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1300 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 graphics processing unit
104 grid scheduler
106 streaming multiprocessor
108 L2 cache
110 system memory
112 bus
114 SIMT processing core
116 tensor core
118 thread scheduler
120 memory management unit
122 L1 cache
124 shared register file
302 execution grid
402 hardware CTA scheduler
502 execution grid
602 unscheduled CTA context
604 CTA scheduling policy
606 CTA type maximum
608 CTA co-execution table
610 register file utilization maximum
612 scratchpad memory utilization maximum
614 CTA contexts maximum
616 streaming multiprocessor scheduling state
618 CTA type utilization
620 register file utilization
622 scratchpad memory utilization
624 CTA context utilization
626 scheduling queue
628 arbiter
630 arbiter
802 parallel processing unit
804 I/O unit
806 front-end unit
808 scheduler unit
810 work distribution unit
812 hub
814 crossbar
816 NVLink
818 interconnect
820 memory
900 general processing cluster
902 pipeline manager
904 pre-raster operations unit
906 raster engine
908 work distribution crossbar
910 memory management unit
912 data processing cluster
914 primitive engine
916 M-pipe controller
1000 memory partition unit
1002 raster operations unit
1004 level two cache
1006 memory interface
1100 streaming multiprocessor
1102 instruction cache
1104 scheduler unit
1106 register file
1108 core
1110 special function unit
1112 load/store unit
1114 interconnect network
1116 shared memory/L1 cache
1118 dispatch
1200 processing system
1202 central processing unit
1204 switch
1206 parallel processing module
1300 exemplary processing system
1302 communications bus
1304 main memory
1306 input devices
1308 display devices
1310 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A data processor comprising:
a plurality of processing units; and
a cooperative thread array scheduler configured to assign subsets of the cooperative thread arrays for co-execution on different ones of the processing units based on resource utilization attributes of the cooperative thread arrays.

2. The data processor of claim 1, wherein the resource utilization attributes are configured in applications from which the cooperative thread arrays are derived.

3. The data processor of claim 1, wherein the resource utilization attributes comprise a first type identifier indicative of a Single Instruction Multiple Thread (SIMT) core resource utilization and a second type identifier indicative of a tensor core resource utilization.

4. The data processor of claim 1, further comprising:
separate cooperative thread array arbiters for each of type of resource utilization attribute.

5. The data processor of claim 1, wherein the cooperative thread array scheduler implements a grid scheduler.

6. The data processor of claim 1, further wherein the cooperative thread array scheduler is further configured to implement a policy comprising permissible cooperative thread array co-execution types.

7. The data processor of claim 6, wherein the cooperative thread array type co-execution policy comprises maximum per-processing unit cooperative thread array type settings.

8. The data processor t of claim 1, wherein the processing units comprise streaming multiprocessors.

9. The data processor of claim 8, wherein each of the streaming multiprocessors is configured to track cooperative thread array occupancy by type.

10. The data processor of claim 1, further comprising logic to form a spatial pipeline of applications from which the cooperative thread arrays are derived.

11. The data processor of claim 10, wherein the applications from which the cooperative thread arrays are derived comprise two or more of a linear deep learning operation, a ReLU deep learning operation, and a layer normalization deep learning operation.

12. A graphics processing unit comprising:
logic to configure a plurality of cooperative thread arrays with different type identifiers prior to assigning the cooperative thread arrays to a plurality of processing units for execution; and
a cooperative thread array scheduler configured to assign subsets of the cooperative thread arrays for co-execution on particular ones of the processing units based on the type identifiers of the cooperative thread arrays and on a resource utilization policy.

13. The graphics processing unit of claim 12, wherein the type identifiers are indicative of primary resource utilization of the cooperative thread arrays.

14. The graphics processing unit of claim 12, wherein the type identifiers comprise a first type identifier indicative of a Single Instruction Multiple Thread (SIMT) core primary resource utilization and a second type identifier indicative of a tensor core primary resource utilization.

15. The graphics processing unit of claim 12, further comprising:
separate cooperative thread array arbiters for each of the type identifiers.

16. The graphics processing unit of claim 12, wherein the cooperative thread array scheduler implements a grid scheduler.

17. The graphics processing unit of claim 12, wherein the cooperative thread array type co-execution policy comprises CTA co-execution associative logic.

18. The graphics processing unit of claim 12, wherein the cooperative thread array type co-execution policy comprises maximum per-processing unit cooperative thread array type settings.

19. The graphics processing unit of claim 12, wherein the processing units comprise streaming multiprocessors.

20. The graphics processing unit of claim 19, wherein each of the streaming multiprocessors is configured to track cooperative thread array occupancy by type.

21. The graphics processing unit of claim 1, wherein the logic to configure the cooperative thread arrays with different type identifiers comprises logic to form a spatial pipeline of the kernels from which the cooperative thread arrays are derived.

22. A process comprising:
configuring a plurality of cooperative thread arrays with resource type identifiers prior to assigning the cooperative thread arrays to a plurality of processing units for execution; and
operating a cooperative thread array scheduler to assign subsets of the cooperative thread arrays for co-execution on particular ones of the processing units based on the type identifiers of the cooperative thread arrays and on a policy for the resource type identifiers.
